(19) United States
(12) Patent Application Publication
(10) Pub. No.: US 2007/0238636 A1
(43) Pub. Date: Oct. 11, 2007

(54) Cleaning composition for polymer machinery

(76) Inventor: Joel Thomson, Elka Park, NY (US)

Correspondence Address: COOPER & DUNHAM, LLP, 1185 AVENUE OF THE AMERICAS, NEW YORK, NY, 10036, US

(21) Appl. No.: 11/401,645

(22) Filed: Apr. 10, 2006

(51) Int. Cl. B29C 33/72; C11D 3/37

(52) U.S. Cl. 510/475; 264/39

(57) ABSTRACT

Compositions and methods for cleaning polymer processing equipment. The compositions contain at least one or more thermoplastic materials or resins and a cross-linking agent such as an organic peroxide. The compositions may also include fillers, blowing agents and lubricants.

### BACKGROUND OF THE INVENTION

When polymeric materials (resins) are processed in an injection molding machine, melting and mixing takes place by means of an elongate screw rotating within a cylindrical barrel. In the course of processing, particularly between jobs, it frequently becomes necessary to clean, or “purge”, the screw from one polymer grade prior to running a second polymer grade. Even during normal processing, some resin inevitably travels through the screw apparatus more slowly than the bulk of material and becomes exposed to enough heat that it begins to decompose. Polymer materials, being carbon-based, will often oxidize and char, turning into a hard-carbon-rich deposit on the surface of the screw. This happens particularly in the upstream melting zone where air trapped between the solid resin pellets brings oxygen into contact with the heated polymer. Production of uncontaminated products requires periodic removal of this residual material, and manual disassembly is extremely labor intensive.

The simplest, though often least effective, method of purging is to simply follow one resin with another, running material through the screw until it comes clean. This may work for straightforward light-to-dark color changes but in many cases hundreds of shots are needed before all traces of the former material are removed. Whenever the subsequent resin is less viscose or is processed at a lower temperature than the former resin, it will freely flow over the screw, taking very little residue along with it. Thus it may appear clean but in reality it contains traces of residual material which show up as color streaks, blisters, or other defects.

A more effective method is to use a commercial purging compound. These materials, though usually more costly than straight resin, are formulated to provide more thorough cleaning. There are three broad categories of commercial compounds. One type is called a physical purging compound, which relies on high viscosity and/or abrasive fillers to scrub and displace residue from the screw. Some grades use resins such as cast acrylic which soften but do not completely melt. In a few grades, a foaming agent is used to increase the internal melt pressure against the screw and barrel. Physical purging agents are generally difficult to expel from the screw due to their high viscosity, and compound retained in dead areas of the screw can contaminate subsequent production.

A second common type of purging compound is called a chemical purging compound. Many chemical compounds are water-based liquids which must be mixed with resin before use. They often contain a solvent or detergent to soften and loosen residue from the screw. A few chemical purging compounds use an alkaline salt to chemically break down polymer residue into a lower molecular weight material. These compounds generally require a soak time to allow the chemicals to penetrate the residue. It is very important to ensure that chemical purging agents of this type do not remain in the screw after production is resumed, since they may compromise the integrity of the next resin. Water-based compounds may also cause dangerous buildups of steam, and can corrode the steel of the barrel and screw.

A third type of purging compound relies on chemical affinity with the polymer residue. This type may contain attributes of a physical purging compound but the primary mechanism of cleaning is the adhesion and mixing of the residue with the purging compound, which in turn is formulated for low adhesion to metal. Affinity may be achieved through the use of blending resins or compatibilizers, which are typically graft or block copolymers comprised of linked polymer chain segments.

### BRIEF SUMMARY OF THE INVENTION

The present invention relates to an improved purging agent of the chemical affinity type, primarily for use with injection molding equipment with a high degree of mechanical agitation. The purging agent has been found to provide both superior adhesion and miscibility with common thermoplastics and low adhesion to the hot steel surfaces inside the machine. This is accomplished by the mechanism of chemically crosslinking the purging agent molecules with each other and with the residual polymer while in the screw.

One object of this invention is to provide a cleaning compound for a polymer processing apparatus having at least one polymeric material and a crosslinking agent. The polymeric material can include at least one thermoplastic material, and can be polyethylene, polystyrene, and/or a styrene-based thermoplastic elastomer. The polymeric material can include at least one organic peroxide or catalyst, and can be dicumyl peroxide, benzoyl peroxide, cumene hydroperoxide, tertiary butyl hydroperoxide, tertiary butyl peracetate, tertiary butyl perbenzoate, and/or ditertiary butyl azodiisobutylnitrile. The compound can also include one or more fillers, which may be abrasives, and can be calcium carbonate, wollastonite, mica, feldspar and/or glass. The compound can also include a blowing agent and/or a lubricant.

Another object of the invention is provide a cleaning compound for a polymer processing apparatus including polyethylene, polystyrene, styrene-based thermoplastic elastomer, filler, and a cross-linking linking agent. In amounts by weight, the polyethylene can be 5-25%, the polystyrene can be 30-60%, the styrene-based thermoplastic material can be 10-20%, the mineral filler can be 20-40%, and the crosslinking agent can be 0.05-0.25%. Also, in amounts by the weight, the polyethylene can be 10-15%, the polystyrene can be 40-50%, the styrene-based thermoplastic material can be 10-15%, the mineral filler can be 25-30%, and the crosslinking agent can be 0.1-0.2%.

A further object of the invention is to provide a procedure for cleaning polymer processing apparatus having the steps of: (a) introducing a cleaning compound having at least one thermoplastic material and a cross-linking agent to a melt processing part of the apparatus; (b) contacting the cleaning compound with the melt processing part and residual melt; and (c) removing the cleaning compound and residual melt from the melt processing part. The procedure can also include the one or more of the following steps: introducing new thermoplastic material to the melt processing part for processing by the apparatus; operating the apparatus until output from the apparatus is substantially only the new thermoplastic material; and/or agitating the cleaning compound with the residual melt on the melt processing part. Also, the melt processing part can be a barrel of the machine, a screw of the machine, and/or a nozzle of the machine.

### DETAILED DESCRIPTION OF THE INVENTION

One ingredient in the present purging agent is a high molecular weight high density polyethylene with a melt index of 0.5-5.0 as defined by American Society for Testing and Materials (ASTM) Standard D-1238). This ingredient serves as a fluid carrier and molecular backbone for the other ingredients. Polyethylene may comprise 5%-25% of the total composition by weight, with the preferred range being 10%-15%.

A second ingredient in the present invention is a heat-stabilized polystyrene with a melt index of 2.0-5.0. Polystyrene resins and copolymers thereof are known to brown and char under prolonged exposure to temperatures over 400° F. (204° C.), and since normal processing temperatures often exceed this, a heat stabilized polystyrene is preferred over alternatives such as general purpose polystyrene or styrene-acrylonitrile copolymer. Polystyrene, being an aromatic polymer, has affinity for a range of polymers that the aliphatic polyethylene does not have. Polystyrene may comprise 30%-60% of the total composition by weight, with the preferred range being 40%-50%.

A third ingredient in the present invention is a styrene-based thermoplastic elastomer, which acts as a compatibilizer between the polyethylene phase and the polystyrene phase. This ingredient may be a block copolymer of styrene-butadiene-styrene, or preferably styrene-ethylene-butadiene-styrene, such as marketed by Kraton Polymers US, LLC of Houston, Texas under the trademark KRATON® G, which has a higher thermal stability. Thermoplastic elastomer may comprise 10%-20% of the total composition by weight, with the preferred range being 10%-15%.

A fourth ingredient in the present invention is an inorganic mineral filler, which serves as an abrasive. Calcium carbonate is the preferred filler, although wollastonite, mica, feldspar, or glass may also be used. Filler may comprise 20%-40% of the total composition by weight, with the preferred range being 25%-30%.

A fifth ingredient in the present invention is a crosslinking agent or catalyst. The preferred crosslinking agent is an organic peroxide such as dicumyl peroxide, sold under the trademark DI-CUP® R by Geo Specialty Chemicals of Gibbstown, N.J. However, other examples of useful catalysts include, but are not limited to, benzoyl peroxide, cumene hydroperoxide, tertiary butyl hydroperoxide, tertiary butyl pqracetate, tertiary butyl perbenzoate, ditertiary butyl azodiisobutylnitrile, and mixtures thereof. The organic peroxide decomposes in the presence of heat and releases alkoxy radicals which in turn abstract hydrogen from polymer molecules, particularly aliphatic chains containing CH₂ units, forming polymer radicals. The recombination of two polymer radicals forms a strong carbon-to-carbon bond between polymer chains. In the preferred embodiment of the invention, the crosslinking agent comprises 0.1%-0.2% of the total composition by weight.

The following table summarizes various embodiments of the subject invention by percent weight:

| Component | Broad range | Preferred range |
|---|---|---|
| Polyethylene | 5-25 | 10-15 |
| Polystyrene | 30-60 | 40-50 |
| Styrene-based elastomer | 10-20 | 10-15 |
| Mineral filler | 20-40 | 25-30 |
| Organic peroxide | 0.05-0.25 | 0.1-0.2 |

Chemical crosslinking between the purging agent and the residual polymer is useful to prevent re-adhesion to the metal machine components and ensure entrapment of the residue when the purging agent is finally expelled from the machine barrel.

Besides forming crosslinks with aliphatic molecules present in the residual polymer being cleaned, chemical crosslinking between polyethylene molecules within the purging agent serves to increase the viscosity and counteract any loss of molecular weight due to thermal degradation while the compound is in the heated barrel.

It has been found that cleaning effectiveness in some cases can be improved by the addition of a chemical blowing agent, for example a mixture containing sodium bicarbonate and citric acid, which reacts to form carbon dioxide with the application of heat. The carbon dioxide, under pressure inside the barrel, remains as a liquid and acts as a solvent on polymer residue. As pressure is released, the carbon dioxide vaporizes and exerts pressure on the cleaning compound which improves contact with the polymer residue and metal walls.

It has been found that a minor fraction of a lubricant such as high molecular weight silicone or fluoropolymer concentrate can aid cleaning effectiveness by improving lubricity between the cleaning composition and the metal walls of the screw and barrel. This is particularly useful for aiding the expulsion of the mixture of cleaning compound and residue bonded thereto. Lubricant is also useful for increasing slip between the cleaning compound and the metal, which increases the scrubbing power of the inorganic abrasive.

The compound in the present invention is found to work best when subjected to a high degree of mechanical agitation. The chemical bonding between molecules requires physical proximity which is normally not present due to the high viscosity of polymer melts. A molding machine equipped with a bidirectional non-return valve such as is produced by Spirex Corporation of Youngstown, Ohio has been shown to be more effective with the present compound.

### EXAMPLES

Comparative Example—A 65 ton injection molder with a 42 mm barrel, manufactured by Cincinnati Milacron of Batavia, Ohio, was processing black acrylonitrile-butadiene-styrene (ABS) resin with a melt index of 5. After the resin source was removed and all possible remaining resin extruded from the barrel, sixteen ounces of a reference commercial purging compound, sold under the trademark ASACLEAN® Advantage™ grade manufactured by Asaclean Sun Plastech of Parsippany, N.J., was passed through the barrel and expelled. The feed screw was removed and examined. A considerable amount of ABS was observed along the trailing edge of the screw flights in the transition melting zone of the screw.

Example 1—The injection molder described above was again filled with black ABS resin and run for one hour. After the resin source was removed and all possible remaining resin extruded from the barrel, sixteen ounces of the compound described in the present invention was passed through the barrel and expelled. The feed screw was removed and examined. Virtually no ABS resin was observed in the screw flights.

Example 2—A 180 ton injection molder with a 40 mm barrel, manufactured by Toshiba Machine Co. of Japan, was processing red polypropylene with a melt index of 25. After purging with ten ounces of the compound described in the present invention, white polypropylene was introduced. After nine shots no remaining red color was visible in the white parts.

Example 3—A 160 ton injection molder with a 55 mm barrel, manufactured by Cincinnati Milacron, was processing red ABS with a melt index of 5 for twelve hours. After purging with sixteen ounces of the compound described in the present invention, tan ethylene-vinyl-acetate (EVA) with a melt index of 25 was introduced. After six shots no remaining red color was visible in the tan parts.

The present invention has been described by way of exemplary embodiments to which it is not limited. Variations and modifications will occur to those skilled in the art without departing from the scope of the present invention as recited in the appended claims and equivalents thereof.

What is claimed is:

1. A cleaning compound for a polymer processing apparatus comprising at least one polymeric material and a crosslinking agent.

2. The compound according to claim 1 wherein the polymeric material comprises at least one thermoplastic material.

3. The compound according to claim 2 wherein each of the thermoplastic materials is selected from the group consisting of polyethylene, polystyrene, and a styrene-based thermoplastic elastomer.

4. The compound according to claim 1, wherein the compound further comprises a filler.

5. The compound according to claim 4 wherein the filler is an abrasive.

6. The compound according to claim 4 wherein the filler is selected from the group consisting of calcium carbonate, wollastonite, mica, feldspar and glass.

7. The compound according to claim 1 wherein the crosslinking agent is an organic peroxide.

8. The compound according to claim 1 wherein the crosslinking agent is selected from the group consisting of dicumyl peroxide, benzoyl peroxide, cumene hydroperoxide, tertiary butyl hydroperoxide, tertiary butyl peracetate, tertiary butyl perbenzoate, and ditertiary butyl azodiisobutylnitrile.

9. The compound according to claim 1, further comprising a blowing agent.

10. The compound according to claim 1, further comprising a lubricant.

11. A cleaning compound for a polymer processing apparatus comprising polyethylene, polystyrene, styrene-based thermoplastic elastomer, filler, and a cross-linking linking agent.

12. The cleaning compound of claim 11, wherein the compound comprises:
polyethylene in amounts of 5-25% by weight;
polystyrene in amounts of 30-60% by weight;
styrene-based thermoplastic material in amounts of 10-20% by weight;
mineral filler in amounts of 20-40% by weight; and
crosslinking agent in amounts of 0.05-0.25% by weight.

13. The cleaning compound of claim 11, wherein the compound comprises:
polyethylene in amounts of 10-15% by weight;
polystyrene in amounts of 40-50% by weight;
styrene-based thermoplastic material in amounts of 10-15% by weight;
mineral filler in amounts of 25-30% by weight; and
crosslinking agent in amounts of 0.1-0.2% by weight.

14. A method of cleaning a polymer processing apparatus comprising the steps of:
introducing a cleaning compound comprising at least one thermoplastic material and a cross-linking agent to a melt processing part of the apparatus;
contacting the cleaning compound with the melt processing part and residual melt; and
removing the cleaning compound and residual melt from the melt processing part.

15. The method of claim 14 further comprising the steps of:
introducing new thermoplastic material to the melt processing part for processing by the apparatus; and
operating the apparatus until output from the apparatus is substantially only the new thermoplastic material.

16. The method of claim 14 further comprising the step of agitating the cleaning compound with the residual melt on the melt processing part.

17. The method of claim 14 wherein the melt processing part is selected from the group consisting of a barrel of the machine, a screw of the machine, and a nozzle of the machine.
